(19) United States
(12) Patent Application Publication
(10) Pub. No.: US 2007/0226213 A1
(43) Pub. Date: Sep. 27, 2007

(54) Method for ranking computer files

(76) Inventor: Mohamed Al-Masri, Waterloo (CA)

Correspondence Address: MOHAMED AL-MASRI, 570 BUCKINGHAM BLVD., WATERLOO, ON, N2T 2T8, CA

(21) Appl. No.: 11/386,735

(22) Filed: Mar. 23, 2006

(51) Int. Cl. G06F 17/30

(52) U.S. Cl. 707/7

(57) ABSTRACT

A method for ranking computer files on a computer system that at least includes: establishing a plurality of files on a computer system, determining an activation value for a set of file and operating system attributes, examining at least portion of a computer system; for each file encountered, applying the file weight accumulation according to their activation values; and assigns importance ranks to each file.

### BACKGROUND OF THE INVENTION

A. Field of the Invention

A method assigns importance ranks to files on a computer system. The rank assigned to a file is calculated from the weights of file attributes matched, system attributes referring to it, and additional custom defined policies. In addition, the rank of a file is calculated from a threshold constant used as a fine-tuning factor. The present invention is particularly useful for enhancing the performance of locating files on a computer system and relates to a precursor of operations such as desktop search, backup, migration, synchronization, disaster recovery, and others.

B. Background

Advances in computer technology and increase in its popularity have profoundly contributed to large numbers of people creating, modifying, and exchanging files. For instance, internet is frequently used to search for information or content that can be downloaded or exchanged in the form of files. In addition, large numbers of people use computers to create their own files or store important information associated to a user, organization, institution or a business. For instance, people depend on software applications installed on computer systems to create new files that contain some form of information. While the internet enabled users to exchange information (i.e. in the form of files), software applications remain a fundamental resource in the creation and modification of files.

Due to the diversity of software applications, files created are varying in their formats and many software vendors preserve the privacy of their formats and thus locating content within these files becomes inadequate. Software applications installed on computer systems are mainly composed of files and operating system registration information (i.e. registry database entries). However, majority of installed files on operating systems are not user created, and thus are less important to users than operating systems. Users are mainly concerned about their personal files, ones that are newly created and modified after an installation of a software application. For example, when a user installs Microsoft Word 2006 on a computer system, he/she is mainly concerned about Word Documents he/she creates after the installation and would likely attempt to look for files created by the application and not necessarily installation or system files.

Much of the present use of computer systems demands a constant alternating sequence of input and output of information. Therefore, the preservation, desktop search, synchronization, backup, and migration of files are becoming of a great magnitude. Due to the rapid increase in the amount of information on computer systems and the increase in the number of file formats, it is now common for many desktop computer systems to contain thousands and thousands of files.

There are several commercially available software tools that aid technology professionals in various operations such as desktop search, backup, synchronization, and migration. In addition, there exist several approaches for backing up, restoring, synchronizing, and migrating all files of computer systems. Some techniques used the imaging approach which takes a snapshot of the current state of a computer system and attempts to re-establish that state during restoration. Other approaches attempt to locate files either via examining the computer system (including non user-centric, installation, and system files) or through a set of predefined types of files. As a result, locating files typically return tens or hundreds of irrelevant or unwanted files which hide the few relevant ones. In addition, such approaches are time-consuming, less productive, and most importantly are not cost effective.

What is needed is a method that ranks files of importance to a computer user and automates the discovery operation of user-created and system-related files. Improvements to such approaches have been developed which attempt to use the following criteria for locating files on a computer system for operations such as desktop search, backup, synchronization, migration, and disaster recovery: filename; file location; file type; file size; and file content; etc. Precision in judging what files to locate is often neglected and the quality of the results produced by current approaches are low or not productive. Furthermore, current approaches do not offer users the flexibility to control the discovery process of their systems. In addition, current approaches exclude the significance of user interaction with computer systems and do not have the ability to gain intelligence of user-centric files. The present invention is an improvement over traditional approaches and ranks files of importance located on a computer system in such a way that it can later be used for further processing.

The diversity of file types should not be an obstacle in finding ways to locate files quickly and with high precision. Although this diversity of file types and formats adds a new level of sophistication, there is hope of keeping up with the growth of information by finding creative ways to discover better mechanisms for locating files that work within the file structures with which many people are now familiar with.

What is therefore desirable but not taught nor suggested by the prior art, is a method for intelligently to take advantage of the user interaction with a computer system, considering relationships between files, determining the importance of files by examining all possible file attributes (i.e. filename, date created, date last modified, extension, etc. . . . ) or all possible operating system attributes (i.e. most recently used, registered file types, critical application data, etc. . . . ) which function as ranking policies, provide the best possible matches of these attributes that are adjusted by activation values and weight factors, and allow users to establish their own ranking strategies.

### SUMMARY OF THE INVENTION

In examining the aforementioned shortcomings and deficiencies of the current existing tools used for locating files, various aspects of the present invention provide systems and methods the ability to rank files on a computer system. One aspect provides an objective ranking based on file attributes. Another aspect provides an objective ranking based on operating system. Another aspect provides an objective ranking based on file and operating system attributes. Another aspect of the present invention is aimed at ranking files within a computer system whose content varies considerably in importance and quality. Another aspect of the present invention is to provide a file ranking method that is highly scalable and can be applied to large number of files or large portions of computer systems. Another aspect of the present invention is to provide a method for adapting to automatically and intelligently determine computer files relevant to a given request for locating files and rank each file based on the relevance that is calculated dynamically. Other aspects of the invention will become apparent in the view of the following description and associated figures.

The present invention provides a method adapted to automatically rank computer files at least including: a repository builder adapted to establish plurality of ranking strategies; a computer system examiner adapted to examine at least a portion of computer files; a file graph planner adapted to build a graph topology and layout of computer files; an inter-layer connector adapted to create relationships between ranking strategies and files examined; an activation establisher adapted to compute the weight for each file; a weight adjuster adapted to fine-tine and adjust weights associated with each ranking strategy; a file ranker adapted to rank each file according to a ranking scheme; and a result processor adapted to process results obtained from ranking for further operations.

### BRIEF DESCRIPTION OF THE DRAWING FIGURES

Features and advantages of the present invention will become apparent to those skilled in the art from the description below, with reference to the following drawing figures, in which:

FIG. 1 is a schematic diagram of the present invention for ranking computer files;

FIG. 2 is schematic diagram of the InfoRank (IR) portion of the method of FIG. 1;

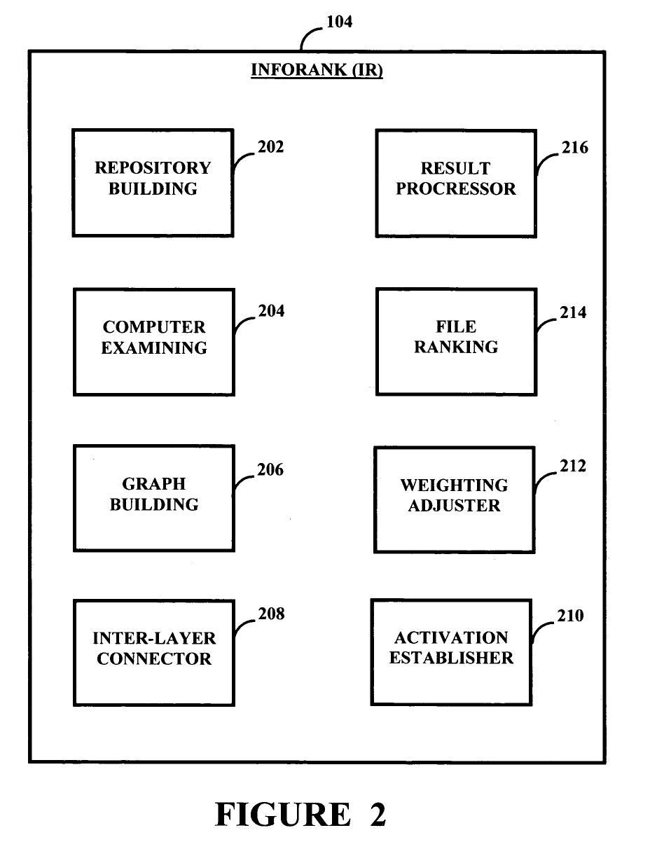

FIG. 3 is a flowchart detailing the present invention method for ranking computer files.

FIG. 4 is a schematic diagram of the Repository Building portion of the method; and

FIG. 5 is a schematic diagram of a policy builder for the file attribute date last accessed.

### DESCRIPTION OF THE DESIGN, IMPLEMENTATION, AND THE PREFERRED EMBODIMENTS

Although the following detailed description contains many details for illustration purposes, advantages of the present invention will become evident to those skilled in the art and will appreciate that many variations and alterations to the following details are within the scope of the invention.

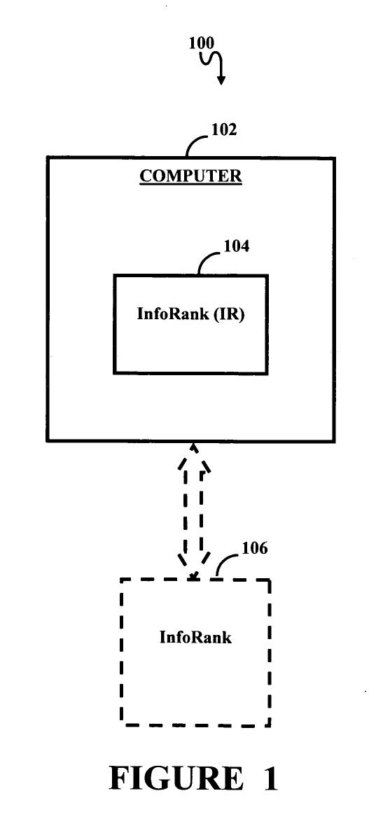

A schematic diagram of the present invention 100 for intelligently locating files and ranking files based on importance is shown on FIG. 1. The computer 102 shown, while typically a desktop or a notebook variety, need not to be so limited. There can be used a wide variety of different computer system sizes and types, as well as other electronic devices and systems for this present invention. The present inventive, referred to here as InfoRank (IR) 104, is a method that can be integrated into a software tool and can be installed on a computer system 102. Alternatively, the IR 104 can be executed through internet browsers or can reside external to the computer 102, as shown by the option labeled 106.

An operating system acts as the brain of the computer system and attempts to organize, regulate activities, and execute commands which are mainly dependent on file structure for storing information. Although there is a wide variety of file formats and types, all files share common attributes or features. File attributes (i.e. filename, date created, date modified, last accessed, extension, etc.) are common across all files and recognized by an operating system. A repository building 202 retrieves the possible combination of attributes and creates a collection of policies that function as the ranking plan for the IR 104. The IR 104 examines the contents of the computer system 102 to consider each file symbolically via a file examining module 204. Also, IR 104 forms a graph topology 206 of computer files and associated file and system attributes which are represented in a multilayer graph of N nodes, and m layers. Layers are used to differentiate inputs, attributes, and outputs. An input layer (i.e. file represented by a node at the first layer) can have interconnections with nodes at the second layer (i.e. attributes represented by nodes in the second layer) which can be activated and therefore used to calculate the output (i.e. a value represented by nodes in the third layer). The IR begins a matching process using inter-layer connections 208 between the ranking plan 206 and collected information from the examining module 204. The IR 104 further determines by the activation establisher 210 the attributes with their associated policies that will contribute to the ranking of files through the inter-layer connections 208 and can adjust the weights of these inter-layer connections (symbolically via a weight adjuster module 212). The IR further ranks encountered files (symbolically via a file ranking module 214).

In the preferred embodiment, all ranked files are presented to the user with a ranking, giving the user a chance to decide which files are important, and therefore are appropriate for further processing (e.g., desktop search, backup, migration, synchronization, etc.), or which files are either system files, or should nonetheless be ignored. In an alternate embodiment, the IR 104 can automatically identify the files that it determines are appropriate for further processing in one collection, and identify all other files in a separate group not recommended for further processing. Those skilled in the art to which the present invention pertains will appreciate that the IR can use scripts or integrate the use of markup language techniques to accomplish the grouping operation and automatically select the appropriate files for further processing (e.g., desktop search, backup, migration, synchronization, etc.).

The files can take on many additional forms, including user data as keys and values that are used for defining user system settings.

The IR 104 ranking method of the present invention is more intelligent and complex than calculating the activation values for each node and produces far superior results. In a simple file ranking, the rank of a file A which has n interconnections with w activation values is simply
IR(A)=n*w
The interconnections between layers are weighted differently. The following equation defines the rank of file A for the present invention more precisely

$$IR ( i ) = {\sum }_{h = 1}^{n} {a}_{h} {w}_{hi} + {θ}_{i} ,$$

where A.sub.h, . . . ,A.sub.n are the number of inter-layer connections between files layer and attributes layer, IR(A.sub.h), . . . ,IR(A.sub.n) are their ranks, and .theta. is a constant in the interval [0,1]. The definition of IR is more complex and subtle than simple summation of weights contributed by attributes associated with policies. The above definition yields a file rank that increases as the number of attributes increases. In addition, there can be a degree of sophistication to expand the attributes into levels of priority which means that some attributes can contribute higher activation values than others. Therefore, a file that is determined to have a high score (i.e. based on the total activation values computed) yields higher file rank. In addition, the input of files can be expanded to a new level of sophistication so that files created by a user are shown on a layer that contains higher activation values while the remaining files (i.e. system files) are on a separate layer with lower activation values which yields higher ranks for files created by the user (i.e. user centric) and lower ranks for other files (i.e. system files) in which IR 104 assigns importance ranks to files. The constant theta. in the formula is interpreted as a threshold value used to adjust the weights of the inter-layer connections 208.

In order to illustrate the present method of file ranking, consider a simple practical example of four files: Car.jpg; Resume₁₃old.doc; Somefile.gll, Unkown.sys. Assume that the following four files are stored on Microsoft Windows based computer system and have been encountered by the IR 104 (with attributes such as location, filename, extension, and date last accessed).

1) C:\My Documents\Favorite Pictures\Car.jpg: Mar. 10, 2005

2) C:\My Documents\Resume₁₃old.doc: Jun. 9, 2004

3) C:\Windows\Somefile.gll: May 1, 2001

4) C:\Windows\Drivers\Unkown.sys: May 1, 2001

The results of the IR 104 file ranking 312 are:

| | Date | |
|---|---|---|
| File | Last Accessed | Rank |
| 1) C:\My Documents\Favorite Pictures\Car.jpg | Mar. 10, 2005 | 95% |
| 2) C:\My Documents\Resume_old.doc | Jun. 9, 2004 | 85% |
| 3) C:\Windows\Drivers\Unkown.sys | May 1, 2001 | 65% |
| 4) C:\Windows\Drivers\Somefile.gll | May 1, 2001 | 45% |

The file 1) receives the highest ranking (95%) for being located in %my documents% directory, being the most recently accessed file (with “recent” being definable), filename contains a reserved word “Car” (with “filename” being definable), and file extension “.jpg” is a registered file application type (with “registered” being definable). On the other hand, file 3) receives 65% ranking due to the fact that it is not user created; located in a system related directory “%Windows/Drivers%”, contains no common keywords in the filename, contains a “.sys” extension which is known to be system related and was from the least accessed files. The file 4) shares similarities with file location and date last accessed of that of file 3), however, file 4) receives 45% ranking for having no keywords reserved in the filename and a file extension that is not completely recognized by the method nor the operating system and therefore file 4) receives slightly less ranking than file 3). On the other hand, file 2) receives 85% ranking being the second most recently accessed, contains reserved keyword in the filename, and is located in %my documents%. However, file 2) receives lower ranking than that of the file 1) due to the fact that the filename contains the word “old” in addition to the date of last accessed. The decisions taken by the IR 104 when processing files 1) through 4) depends on threshold values, activation values, and intelligent techniques derived from attributes and their associated policies. As illustrated by this example, the more information that can be collected about the file, the better chances for having far superior file ranking. The ranking plan contains a set of policies originally derived from attributes to be compared to the collected 204 attributes for each file encountered. The IR 104 determines the amount of weight contribution each file receives from the matching policies through the activation establisher 210. The IR 104 further processes this information to determine the values (total weight) each file accumulates which is used to compute the rank of a file.

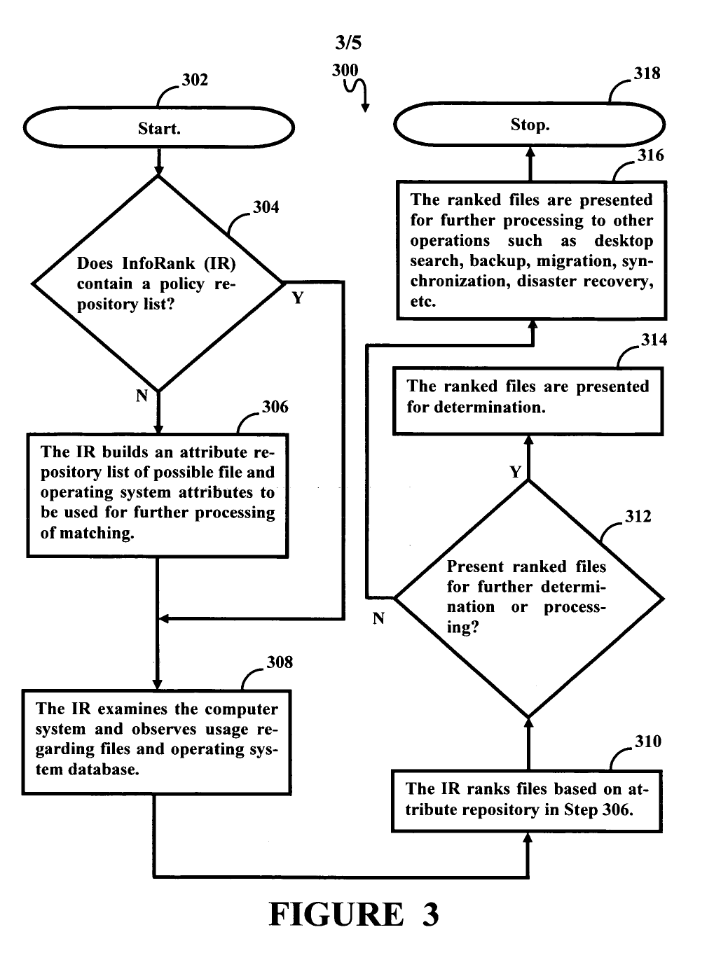

The flowchart in FIG. 3 summarizes the general method 300 used by the IR to rank computer files. The method starts (Step 302) with an initialization process, and then IR determines whether it contains a policy repository list (Step 304). If IR does not contain the policy repository list (Step 304) it builds a list of the possible file, system, and custom defined attributes that make up policies and assigns weights to each policy later used for ranking files (Step 306), otherwise the method continues with Step 308. The IR scans the computer system (Step 308), examines files, and begins collecting information about each file in addition to system database. The IR begins a comparison routine with assigning scores to each file based on matched policies from Step 304. In Step 312, the IR determines whether results will be presented to the user for further interaction (Step 314), or whether the results will be used for further processing to other operations (Step 316). The method stops in Step 318.

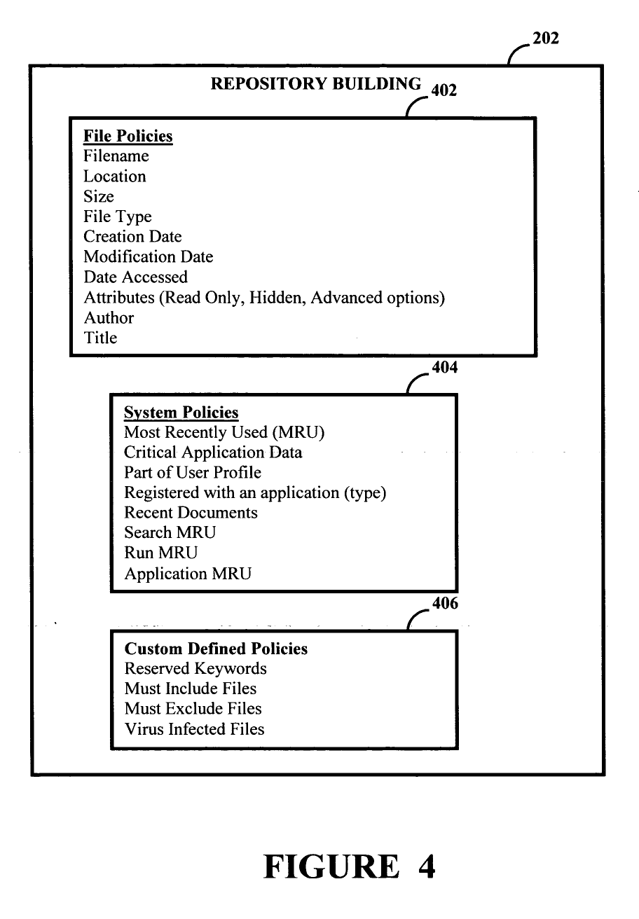

There are wide numbers of file attributes. File attributes are those features that can be extracted about each file individually. However, in order to be able to rank files appropriately, other attributes such as system attributes can be used to complement those of file attributes. For example, a file attribute such as date created (with “date created” being definable) is essentially important to the IR 104 since IR 104 will have some activation values for those files created within two days ago to be higher than those created ten days ago. In addition, files that are created recently and appear under the system attribute of Most Recently Used (MRU) (with “MRU” being definable) under the operating system database, will eventually receive even higher activation values since these files contain attributes that match more nodes, accumulate more activation values, and thus receive high score. The IR 104 provides the flexibility to user to expand the ranking strategies by adding additional attributes to be tailored to the user's particulars. For example, when examining a computer system, the IR filters infected files by including an exclude custom policy that contains a list of all infected file names (with “exclude” being definable) and avoids presenting unwanted results. FIG. 4 depicts the Building Repository 202 with some of the possible file policies 402, system policies 404, and custom defined policies 406, however, for anyone of ordinary skill in the art will appreciate that many variations and alterations to file, system, and custom attributes are within the scope of the invention.

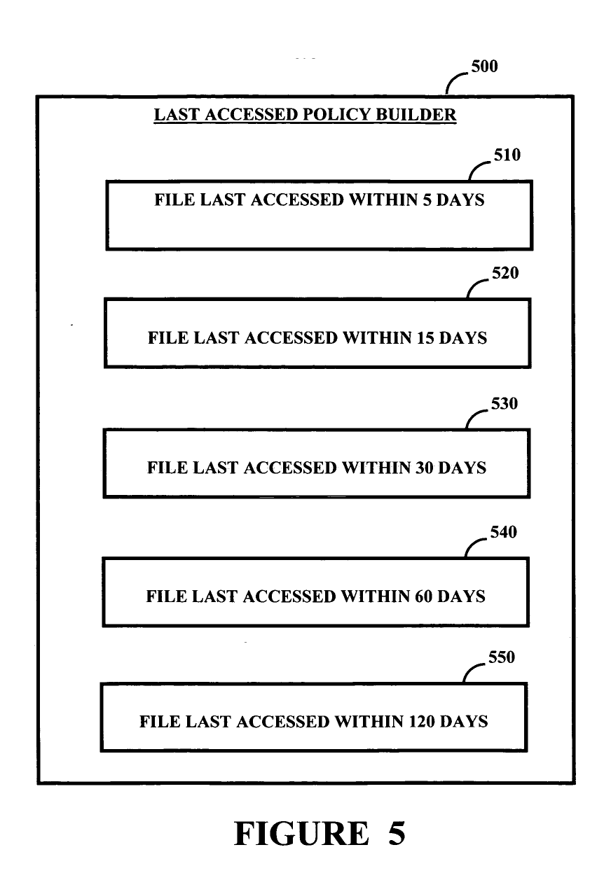

The diagram on FIG. 5 illustrates another example of policies that derive from attributes. For this illustration, the attribute associated with a file of date last accessed is used. The date last accessed being definable is shown on FIG. 5. A date last accessed can build policies such as file was last accessed within 5 days (Step 510), within 15 days (Step 510), within 30 days (Step 530), within 60 days (Step 540), or within 120 days (Step 550). The policies that are more recent receive higher weighting, respectively. Other policies are derived from other attributes where each attribute is assigned a weight and each policy within an attribute is also assigned additional weights. These weights are used serve as the ranking plan used to assign score to each file.

The files which are designated for further processing are presented to the appropriate tool for further processing according to the operation involved such as desktop search, backup, synchronization, migration, disaster recovery, etc.

Variations and modifications to the present invention are possible, given the above description. However, all variations and modifications which are obvious to those skilled in the art to which the present invention pertains are considered to be within the scope of the protection granted by this Letter Patent.

What is claimed is:

1. A computer implemented method of scoring a plurality of computer files, comprising:
a) establishing a plurality of file-specific policies;
b) establishing a plurality of system-specific policies;
c) establishing a plurality of custom-defined policies;
d) choosing a weighting factor for each said policy;
e) creating a graph topology for files;
f) examining at least a portion of a computer system files;
g) assigning a score to each of file based on scores of the of one or more policies matched;
h) processing the files according to their scores.

2. The method of claim 1, wherein the assigning includes:
identifying a weighting factor for each of the files, the weighting factor being dependent on the number of policies matched, and
adjusting the score of each of the files based on the identified weighting factor.

3. The method of claim 1, wherein the assigning includes:
identifying a weighting factor for each file, the weighting factor being dependent on a threshold value, and
adjusting the score of each of the files based on the threshold value.

4. The method in claim 1, further comprising:
automatically adjusting and modifying the weighting of policies based on perceived user interaction with computer system.

5. The method in claim 1, wherein said policies comprise:
considering recent usage of a file, and
considering recent search pattern.

6. The method in claim 1, wherein said policies comprise:
considering whether file name includes at least portion of user's profile name, and considering file name contains at least one or more reserved keywords.

7. The method in claim 1, wherein said policies comprise:
considering whether a file is listed in at least one or more locations in the system database, and
considering whether a file header contains information about the author, title, owner, or comments.

8. The method in claim 1, wherein said policies are modifiable by a user via a graphical user interface, script or any markup language.

9. The method in claim 1, further comprising:
processing the collected files based on matching policies.

10. The method in claim 1, wherein the assigning score includes:
determining the score based on (1) number of matched policies and (2) an importance to other files.

11. The method in claim 9, wherein the importance of each of the files is based on a number of matching policies that a file collects.

12. The method in claim 9, wherein the importance of each of the files is based on weights to each of the policies matched, and determining a score for each of the files based on a number of matched policies and the weights assigned to each policy

13. The method in claim 1, wherein said policies comprising:
allowing a user to modify said weights of file policies.

14. The method in claim 9, wherein the processing of files includes:
organizing files based on determined scores.

15. The method in claim 9, wherein said processing of files includes:
organizing files into categories based on determined scores.

16. The method in claim 9, wherein said processing of files includes:
organizing files into categories of importance to a user based on determined scores.

17. The method in claim 9, wherein the assigning weight includes:
assigning different weights to at least some of the policies associated with at least one of the collected file.

18. The method in claim 1, wherein the assigning of a score includes:
determining the score primarily based on policies matched.

19. The method in claim 1, further comprising:
a policy adjuster adapted to automatically modifying the weighting of the policies based in perceived user computer system usage.

20. The method in claim 1, further comprising:
processing scores to other computer implemented methods or modules.
